(19) United States
(12) Patent Application Publication
(10) Pub. No.: US 2004/0086766 A1
(43) Pub. Date: May 6, 2004

(54) Fuel cells

(76) Inventors: Herbert Hartnack, Erlangen (DE); Josef Lersch, Heroldsbach (DE); Arno Mattejat, Bubenreuth (DE); Karl Strasser, Erlangen (DE); Herbert Hartnack, Erlangen (DE)

Correspondence Address: Harness Dickey & Pierce, Suite 600, 11730 Plaza America Drive, Reston, VA, 20190, US

(21) Appl. No.: 10/467,374

(22) PCT Filed: Feb. 1, 2002
(86) PCT No.: PCT/EP02/01078

(30) Foreign Application Priority Data
Feb. 7, 2001 (EP) 01102909.7

(51) Int. Cl. H01M 8/02; H01M 2/08

(52) U.S. Cl. 429/35; 429/38

(57) ABSTRACT

Gas chambers (7, 9) in fuel cells (1) are sealed from the environment in a gas-tight manner by means of seals (11). Said seals (11) are exposed to the chemically very aggressive operating gases at high temperature. According to the invention, a fuel cell (1), has a seal (11), arranged between two components (3, 5), made from a carbon-filled, bisphenol cross-linked fluororubber. Said seal (11) is chemically and mechanically extremely stable, such that each fuel cell (1), in a fuel cell block can be sealed and maintained in position within the fuel cell block by means of single seal (11) in a simple manner.

The invention relates to a fuel cell having two components, a gas space which adjoins the components and a seal which is arranged between the components and seals off the gas space from the external atmosphere.

In a fuel cell, electrical energy and heat are generated by combining hydrogen (H₂) and oxygen (O₂) in an electrochemical reaction, with the hydrogen and oxygen combining to form water (H₂O). For this purpose, hydrogen is passed into an anode gas space of the fuel cell and oxygen is passed into a cathode gas space of the fuel cell. The hydrogen can be fed into the fuel cell either in the form of pure hydrogen or in the form of a hydrogen-containing fuel gas. The oxygen can be fed to the fuel cell in the form of pure oxygen or, for example, in the form of air. When designing a fuel cell per se or a fuel cell block composed of a multiplicity of fuel cells, it should be ensured that the anode gas space is sealed off in a gastight manner from the cathode gas space of a fuel cell. Moreover, the gas spaces of the fuel cell block have to be sealed off from an external atmosphere in such a manner that it is impossible for either of the two operating gases to escape from the fuel cell block. Therefore, the gas spaces of a fuel cell are sealed off using one or more seals.

When the fuel cell is operating, a gas space seal of a fuel cell comes into contact with one of the operating gases of the fuel cell. The operating gases of a fuel cell are chemically highly aggressive, in particular if the fuel cell is operated with pure oxygen. This problem is aggravated by the fact that even low-temperature fuel cells are operated at a temperature of at least 70° C. The chemical attack of pure oxygen in conjunction with a temperature of around or above 70° C. with conventional elastic seals causes the seals to lose their elasticity and mechanical stability.

Therefore, it is an object of the present invention to provide a fuel cell having a gas space seal which is chemically stable with respect to the operating gases.

This object is achieved by a fuel cell having two components, a gas space which adjoins the components and a seal which is arranged between the components and seals off the gas space from the area surrounding the gas space, in which fuel cell the seal comprises at least a partial region made from carbon-black-filled, bisphenol-crosslinked fluororubber.

Years of tests have shown that fluororubber which is filled with carbon black and crosslinked with bisphenol is chemically stable for many hundreds of hours with respect to pure oxygen which has been heated to temperatures of up to 120° C. On account of this chemical stability, the fluororubber does not lose its high dimensional stability, and is therefore able to ensure that a gas space of a fuel cell is reliably sealed off for a prolonged period of time. Moreover, the material can be processed with a reasonable level of outlay in forming tools and has such a low porosity that it is easy to form gastight sealing surfaces. In addition, the material can readily be joined in a gastight manner to metallic surfaces. A further advantage of the bisphenol-crosslinked and carbon-black-filled fluororubber resides in its high electrical resistance. This means that the material is suitable for connecting two components of a fuel cell which are at different electrical potentials during operation of the fuel cell to one another in a gastight and electrically insulating manner.

The seal is shaped in such a way that only carbon-black-filled bisphenol-crosslinked fluororubber comes into contact with one of the or the operating gases. For this purpose, the seal is made from this fluororubber at least in a partial region. The seal may in this case consist entirely of the fluororubber or may be composed of various layers, in which case layers which do not come into contact with the operating gases may also consist of other materials.

The seal may be of single-part or multipart form. Moreover, the gas space does not necessarily have to be sealed off by a single seal, but rather may also be sealed off by a plurality of seals which are separated from one another. Also, it is not necessary for the gas space to be completely sealed off, but rather it is also possible for one or more openings, for example for supplying and discharging gas from the gas space, to remain open. The seal prevents a gas from flowing out of the gas space into the area surrounding the gas space. This surrounding area may be the external atmosphere around the fuel cell or the fuel cell block or may alternatively be a further gas space which is arranged at or around the sealed gas space and is separated from the atmosphere around the fuel cell for example by a further seal.

The two components of the fuel cell are, for example, an interconnector plate and an electrolyte-electrode assembly or two interconnector plates, it being possible for the components to be coated with functional layers which adjoin the seal.

In an advantageous configuration of the invention, the fluororubber is a fluorine-polymethylene rubber. A fluororubber of this type has a very low water uptake, which is advantageous in particular in the case of fuel cells which are operated with humidified operating gases. The material does not swell, does not stick and therefore has a particularly good and prolonged dimensional stability.

The fluororubber expediently has a Shore A hardness of between 60 and 85. A fluororubber with a hardness of this level has a sufficient elasticity to seal off two, for example, metallic components and at the same time has a sufficient compressive strength not to be excessively deformed or even destroyed by the components.

In a further advantageous configuration of the invention, the components are in plate form and the seal is arranged in frame form between the components, in which case the seal spaces the two components apart from one another. In this case, one of the gas spaces of the fuel cell is arranged in the interior of the frame. With a structure of this type, by way of example, an interconnector plate, the frame-like seal and an electrolyte electrode assembly are constructed in layers on top of one another. In this case, the seal has a supporting function. A fluororubber as described above has a sufficient mechanical and chemical stability to ensure that during the service life of the fuel cell it is only deformed to such a minor extent that it is able to perform a supporting function.

In a further advantageous embodiment of the invention, a fuel cell block comprises a multiplicity of fuel cells as described above, the seals in each case embedding the two components and forming an assembly which imparts stability to the fuel cell block. The dimensional stability of the fluororubber allows the seal to be used to impart its stability to the fuel cell block in the assembled state. Moreover, an arrangement of this type has the advantage that, after the plate-like components have been arranged in layers to form the fuel cell block, pressing the plate-like components together not only leads to the formation of a stable fuel cell block, but also, at the same time, seals off the gas spaces inside the fuel cell block.

This considerably simplifies assembly of the fuel cell block.

Moreover, embedding a voltage-carrying component in the seal means that this component is electrically insulated from its surroundings. If embedded components of this type are stacked in the fuel cell block in such a manner that only the seal faces the surrounding area, the components in the fuel cell block are protected from contact with the outside. The risk of short circuits caused by undesirable contact with the components from outside the block is therefore ruled out in a very simple way.

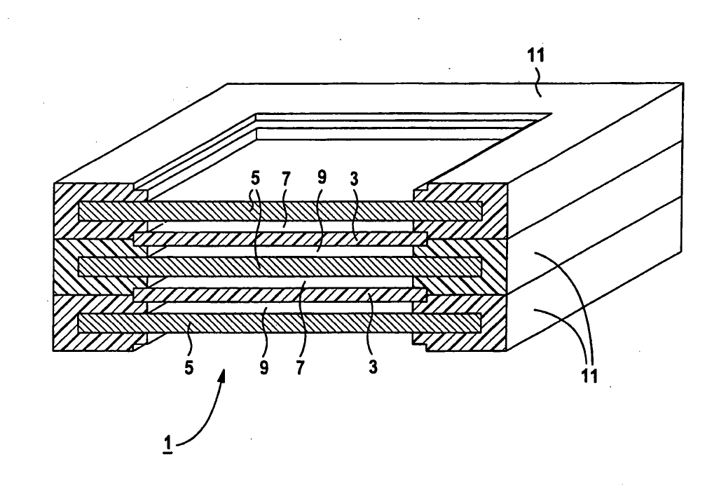

An exemplary embodiment of the invention is explained with reference to a figure. FIG. 1 shows a section through two fuel cells 1, which together with further fuel cells (not shown in FIG. 1) form a fuel cell block. The fuel cells are PEM fuel cells (polymer electrolyte membrane fuel cells) which are designed to operate with pure oxygen as oxidizing gas. Each of the fuel cells 1 comprises an electrolyte electrode assembly 3 and two interconnector plates 5 which adjoin the flat sides of the electrolyte electrode assembly 3. The middle one of the interconnector plates 5 shown in FIG. 1 is therefore part of both fuel cells 1 shown in FIG. 1. The anode gas space 7 and the cathode gas space 9 of each fuel cell 1 are respectively arranged between the electrolyte electrode assembly 3 and the interconnector plates 5. The interconnector plates are thermal components through which water can flow and which can be used to cool or heat the adjoining gas spaces.

The interconnector plates 5 are embedded in frame-like seals 11. The seals 11 consist of carbon-black-filled bisphenol-crosslinked fluororubber or a carbon-black-filled, bisphenol-crosslinked fluorine-polymethylene rubber. A rubber of this type is available, for example, from Gummiwerk Kraiburg GmbH & Co., D-84478 Waldkraiburg as VA 7 AMZ. In each case two seals 11 embed an electrolyte-electrode assembly 3 in a frame-like manner, each seal 11 being configured in such a way that it also extends between the electrolyte electrode assembly 3 and the interconnector plate 5. This part of the seal 11 which extends between the electrolyte electrode assembly 3 and the interconnector plate 5, like the seal 11 as a whole, runs along the edges of the electrolyte electrode assembly 3. The seal is therefore arranged in the manner of a frame between the electrolyte electrode assembly 3 and the interconnector plate 5 and therefore spaces the two components apart from one another. Since the material of the seals 11 has a volume resistivity of more than 10¹⁰ Ω×cm at room temperature, the interconnector plates 5 are in each case kept electrically insulated from one another by the seals 11.

Both above and below the two fuel cells 1 illustrated in FIG. 1 there are further fuel cells (not shown in FIG. 1), which together with the fuel cells 1 which are shown form a fuel cell block. The fuel cells 1 are pressed together by a plurality of tie rods which are not shown in FIG. 1. The pressure which is thereby generated only slightly changes the shape of the seals 11, which have a Shore A hardness of 75. However, the pressure does press together the seals 11 in such a manner that the gas spaces 7, 9 are sealed off in a gastight manner from the area surrounding the fuel cell block. The compressed seals 11 form an assembly which imparts stability to the fuel cell block. Together with the tie rods (not shown), the seals 11 therefore form a self-supporting assembly.

While the fuel cell block is operating, hydrogen and oxygen flow into the anode gas space 7 and the cathode gas space 9, respectively, of each fuel cell 1 of the fuel cell block through feed lines and discharge lines, which are not shown. Therefore, when the fuel cells 1 are operating, each seal 11 comes into contact both with pure hydrogen and with pure oxygen. However, the seals 11 are so chemically and mechanically stable that they are scarcely attacked at all by the operating gases hydrogen and oxygen and retain their shape and sealing properties throughout an operating time of 1000 hours.

1. A fuel cell (1) having two components (3, 5), a gas space (7, 9) which adjoins the components (3, 5) and a seal (11) which is arranged between the components (3, 5) and seals off the gas space (7, 9) from the area surrounding the gas space, characterized in that the seal (11) comprises at least a partial region made from carbon-black-filled, bisphenol-crosslinked fluororubber.

2. The fuel cell (1) as claimed in claim 1, characterized in that the fluororubber is a fluorine-polymethylene rubber.

3. The fuel cell (1) as claimed in claim 1 or 2, characterized in that the fluororubber has a shore A hardness of between 60 and 85.

4. The fuel cell (1) as claimed in one of the preceding claims, characterized in that the components (3, 5) are in plate form and the seal (11) is arranged in frame form between the components (3, 5) and spaces the components (3, 5) apart from one another.

5. A fuel cell block having a multiplicity of fuel cells (1) as claimed in claim 4, in which the seals (11) in each case embed the two components (2, 5) and form an assembly which imparts stability to the fuel cell block.
